(19) United States
(12) Patent Application Publication
(10) Pub. No.: US 2020/0008564 A1
(43) Pub. Date: Jan. 9, 2020

(54) HAND TOOL ASSEMBLY

(71) Applicant: Kun-You Chen, Taichung City (TW)

(72) Inventor: Kun-You Chen, Taichung City (TW)

(21) Appl. No.: 16/027,276

(22) Filed: Jul. 4, 2018

(51) Int. Cl. A46B 5/00; A46B 17/08; B29C 49/00

(52) U.S. Cl. CPC A46B 5/0095; B29C 49/0031; A46B 17/08

(57) ABSTRACT

A hand tool assembly includes a handle having a connection portion formed on one end thereof by way of blow molding, and the connection portion includes a recess defined therein which includes a first inner bottom. At least one hole is defined through the first inner bottom of the recess. A head has the top thereof accommodated in the recess and includes at least one rod which is engaged with the at least one hole. At least one function part is connected to the underside of the head and protrudes beyond the recess. A board is connected between the head and the first inner bottom of the recess such that the head is replaceable.

### BACKGROUND OF THE INVENTION

1. Fields of the Invention

The present invention relates to a hand tool assembly, and more particularly, to a hand tool assembly with a replaceable head.

2. Descriptions of Related Art

The conventional scraper or brush generally includes a handle and a head which is connected to the handle. One of the scrapers uses two plates to clamp the metal scraper, and rivets extend through the two plates and the metal scraper to secure the metal scraper. However, the connection portion between the two plates and the metal scraper is easily broken due to frequently used by force. Another type connection between the handle and the metal scraper is to use a wedge piece to urge the metal scraper. The top plate is used as a cover which is slidable to hide the metal scraper when the metal scraper is not in use. It is noted that the slidable top plate is easily loosened to affect the positioning of the metal scraper.

The present invention is intended to provide a hand tool assembly that is designed to eliminate the drawbacks mentioned above.

### SUMMARY OF THE INVENTION

The present invention relates to a hand tool assembly and comprises a handle having a connection portion which has a recess. At least one hole is defined through the first inner bottom of the recess. A head has the top accommodated in the recess and includes at least one rod which is engaged with the at least one hole. At least one function part is connected to the underside of the head and protrudes beyond the recess.

Preferably, a hollow area is defined in the connection portion and the at least one hole communicates with the hollow area.

Preferably, a protrusion is formed on the outer periphery of the at least one rod and includes an inclined face which tapers outward from the distal end of the at least one rod toward a root of the at least one rod. The at least one rod of the head has a slit defined axially therethrough which opens to the distal end of the at least one rod. The inclined face guides the at least one rod to be inserted into the at least one hole of the first inner bottom of the recess. The at least one rod is deformed because of the slit is narrower to allow the protrusion to pass through the at least one hole, and the protrusion contacts the periphery of the at least one hole after the protrusion passes through the at least one hole.

Preferably, a nut is located in the at least one rod of the head. A bolt extends through the underside of the head and is connected with the nut. The at least one rod is secured between the nut and the periphery of the at least one hole.

Preferably, the recess includes the first inner bottom and multiple first sidewalls, wherein one of the sidewalls includes a slot which includes a second inner bottom and two second sidewalls. A bore is defined through the second inner bottom and communicates with the hollow area. The head includes a resilient member which has one end thereof extending from one side of the head, and a gap is formed between the resilient member and the head. A tongue protrudes from the resilient member, and a stepped portion is formed between the distal end of the tongue and the resilient member. The resilient member is slid along the slot and the second inner bottom pushes the resilient member to narrow the gap until tongue is engaged with the bore to accommodate the head in the recess. The periphery of the bore is engaged with the stepped portion.

Preferably, the at least one function part includes bristles or a scraper.

Preferably, the hollow area of the connection potion is filled with liquid, beads or sand.

The present invention also provide a second embodiment of the hand tool assembly and comprises a handle having a connection portion formed on one end thereof and the connection portion has a recess defined therein which includes a first inner bottom. Multiple holes are defined through the first inner bottom of the recess. A board has the top accommodated in the recess and has multiple rods which are engaged with the holes. One of the rods includes a nut received therein. A function part has the top thereof connected to the underside of the head. An extension extends from the underside of the function part. A bolt extends through the function part and is connected with the nut. The function part is replaceable when the bolt is disengaged from the nut.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the first embodiment of the hand tool assembly of the present invention;

FIG. 2 is an exploded view of the first embodiment of the hand tool assembly of the present invention;

FIG. 3 is an cross sectional view, taken along line III-III of FIG. 1;

FIG. 4 is an enlarged view to show the connection between the rod of the head and the hole in the recess;

FIG. 5 shows another function part of the first embodiment of the hand tool assembly of the present invention;

FIG. 6 is an exploded view of the hand tool assembly disclosed in FIG. 5 of the present invention:

FIG. 7 is an cross sectional view, taken along line VII-VII of FIG. 5;

FIG. 8 is an enlarged view to show the connection between the rod of the head and the hole in the recess by using a bolt;

FIG. 9 is a perspective view to show the second embodiment of the hand tool assembly of the present invention;

FIG. 10 is an exploded view of the second embodiment of the hand tool assembly of the present invention;

FIG. 11 is an cross sectional view, taken along line of FIG. 9;

FIG. 12 is an cross sectional view, taken along line of FIG. 9;

FIG. 13 shows liquid is filled in the hollow area of the connection portion of the hand tool assembly of the present invention;

FIG. 14 is an enlarged view to show the connection between the rod of the head and the hole in the recess of FIG. 13;

FIG. 15 shows sand is filled in the hollow area of the connection portion of the hand tool assembly of the present invention;

FIG. 16 is an enlarged view to show the connection between the rod of the head and the hole in the recess of FIG. 15, and

FIG. 17 shows beads are filled in the hollow area of the connection portion of the hand tool assembly of the present invention.

### DETAILED DESCRIPTION OF THE PREFERRED EMBODIMENT

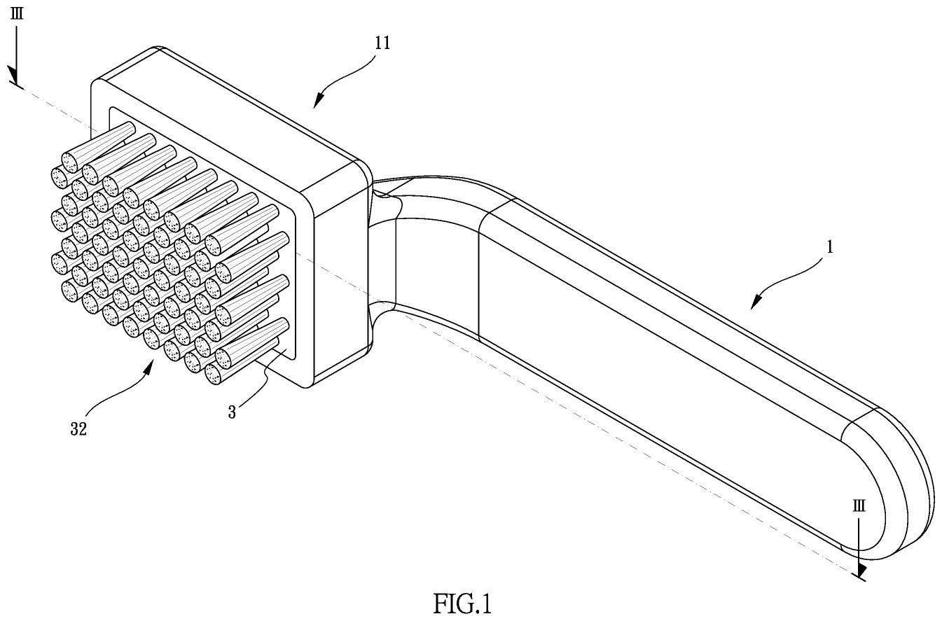

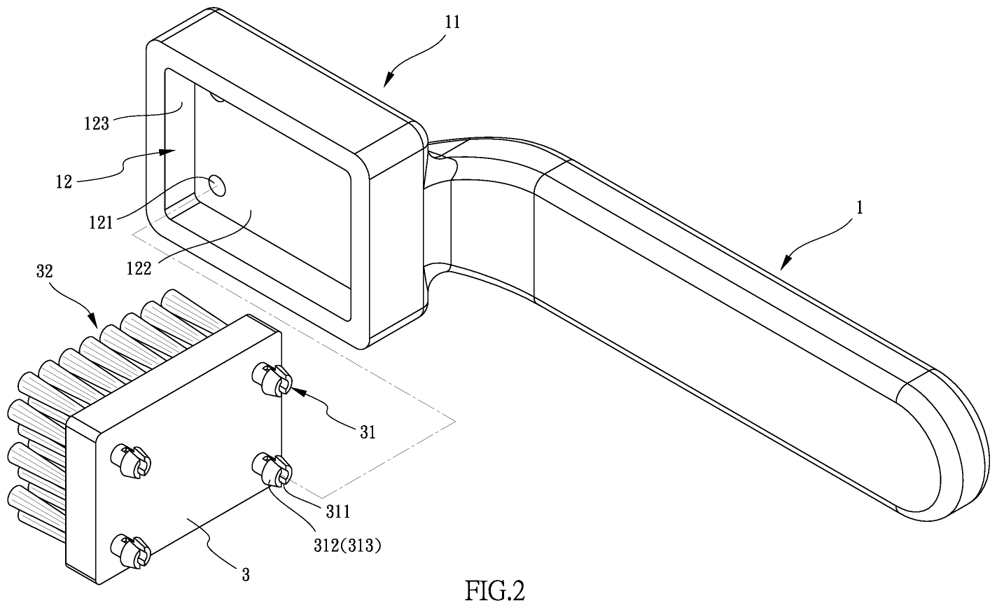

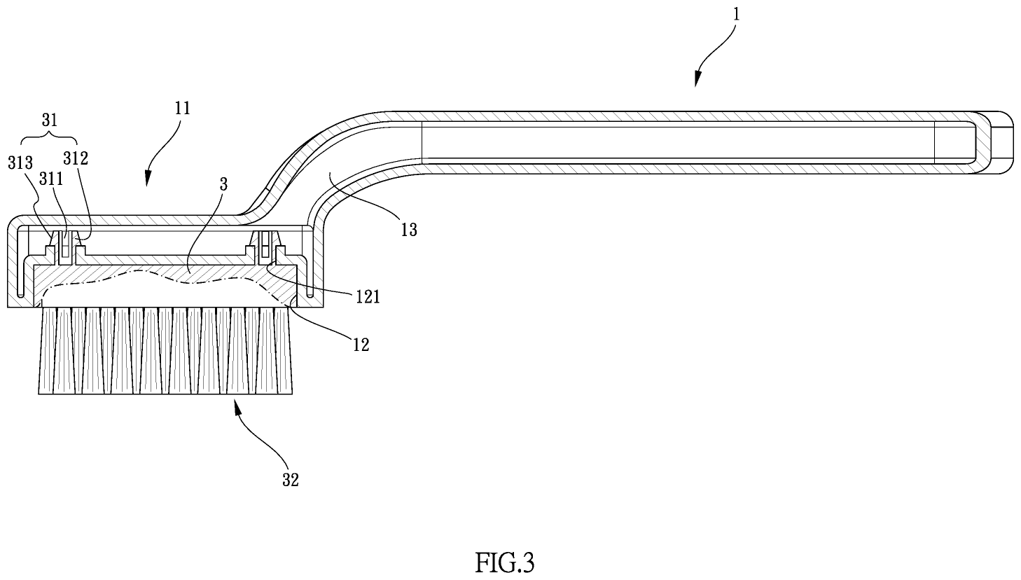

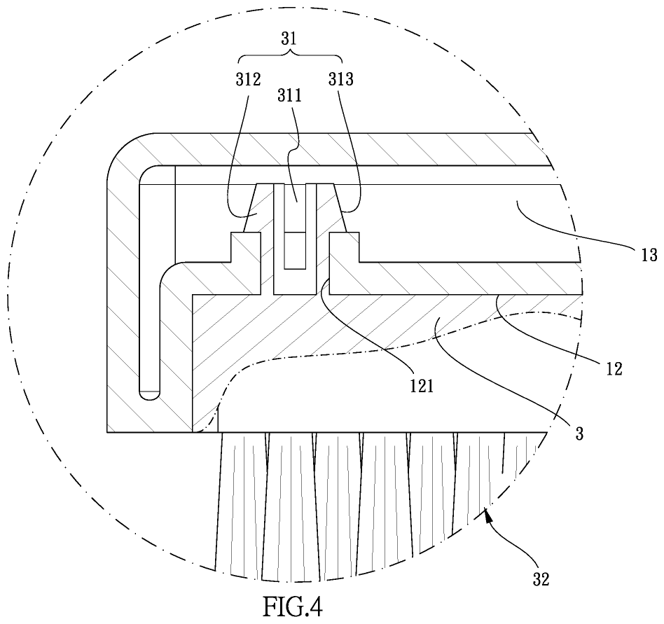

Referring to FIGS. 1 to 4, the hand tool assembly of the present invention comprises a handle 1 having a connection portion 11 formed on one end thereof by way of blow molding. The connection portion 11 has a recess 12 defined therein which includes a first inner bottom 122. At least one hole 121 is defined through the first inner bottom 122 of the recess 12. A head 3 includes the top thereof accommodated in the recess 12 and has at least one rod 31 which is engaged with the at least one hole 121. At least one function part 32 is connected to the underside of the head 3 and protrudes beyond the recess 12. The handle 1 and the connection portion 11 are formed integrally by way of blow molding so that it is strong and light in weight.

The connection portion 11 includes a hollow area 13 defined therein and the at least one hole 121 communicates with the hollow area 13. In this embodiment, the head 3 is a rectangular part and there are four rods 31 on four corners of the head 3. Each rod 31 has a slit 311 defined axially therethrough which opens to the distal end of the rod 31. A protrusion 312 is formed on the outer periphery of each rod 31 and includes an inclined face 313 which tapers outward from the distal end of the rod 31 toward a root of the rod 31. In this embodiment, there are four holes 121 defined through the first inner bottom 122 of the recess 12. When the four rods 31 are inserted into the four holes 121, the inclined face 313 of each rod 31 guides the rod 31 to be inserted into the hole 121 corresponding thereto. Because the tapered protrusion 312, the at least one rod 31 is deformed by narrowing the slit 311 to allow the protrusion 312 to pass through the hole 121, and then after the protrusion 312 passes through the hole 121, the protrusion 312 bounces outward due to the recovery of the slit 311. The underside of the protrusion 312 contacts the opposite face of the first inner bottom 122 and contacts the periphery of the hole 121. By this way, the head 3 is connected to the connection portion 11.

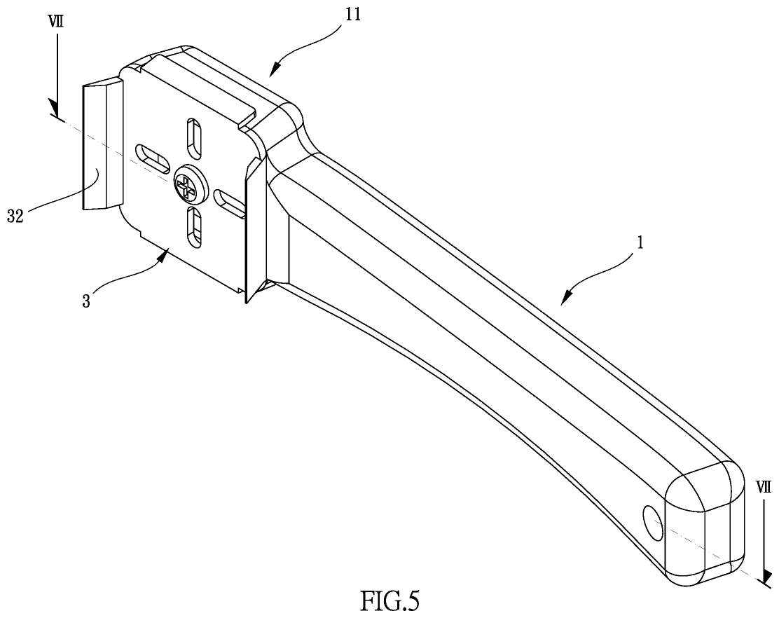

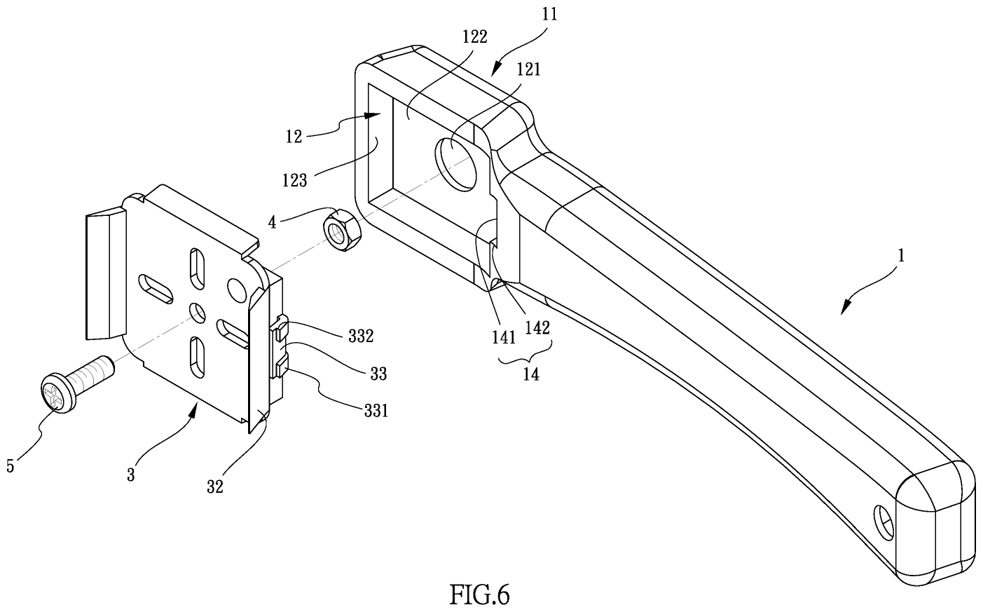

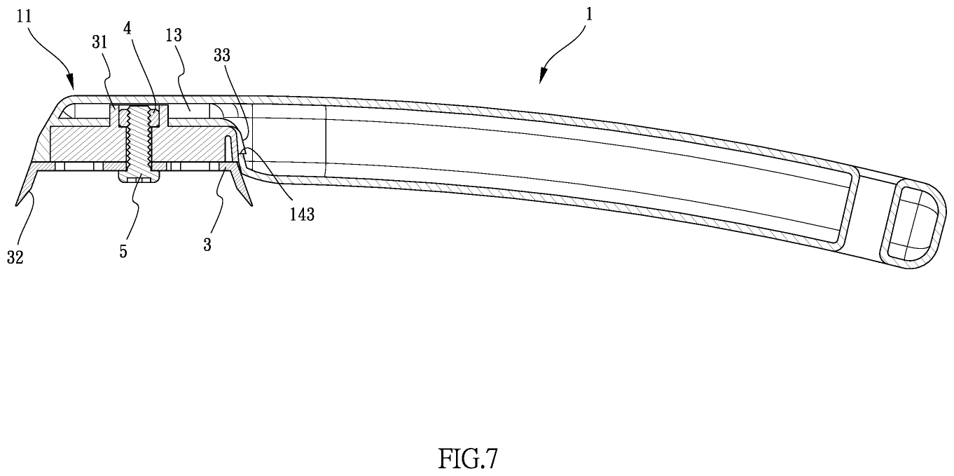

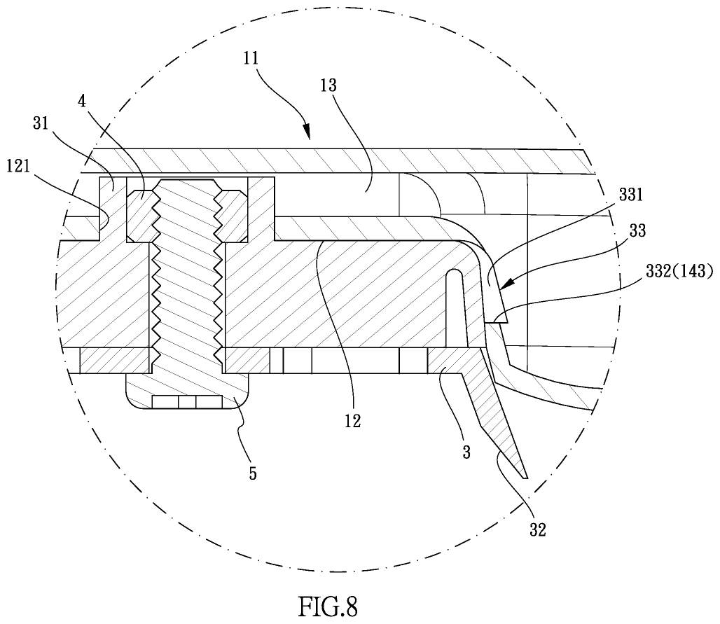

As shown FIGS. 5 to 8, yet another embodiment is that a nut 4 is located in the rod 31 of the head 3, and a bolt 5 extends through the underside of the head 3 and is connected with the nut 4. The nut 4 is a rubber nut which expands when the bolt 5 is connected to the nut 4, the rod 31 is securely positioned between the nut 4 and the periphery of the hole 121. Besides, in order to firmly connect the head 3 to the recess 12, the recess 12 includes the first inner bottom 122 and multiple first sidewalls 123. One of the sidewalls 123 includes a slot 14 which includes a second inner bottom 141 and two second sidewalls 142. The second inner bottom 141 faces the recess 12, and the second sidewalls 142 face the installation direction of the head 3. A bore 13 is defined through the second inner bottom 141 and communicates with the hollow area 13. The head 3 includes a resilient member 33 which has one end thereof extending from one side of the head 3. A gap is formed between the resilient member 33 and the head 3. That is to say, the resilient member 33 extends at an angle relative to the outside of the head 3. A tongue 331 protrudes from the resilient member 33, and a stepped portion 332 is formed between the distal end of the tongue 331 and the resilient member 33. The resilient member 33 is slid along the slot 14, and the second inner bottom 141 pushes the resilient member 33 to narrow the gap until tongue 331 is engaged with the bore 143 to accommodate the head 3 in the recess 12. The periphery of the bore 143 is engaged with the stepped portion 332. The head 3 is firmly connected in the recess 12 of the connection portion 11 by the cooperation between the resilient member 33 and the bore 143, and between the bolt 5 and the nut 4.

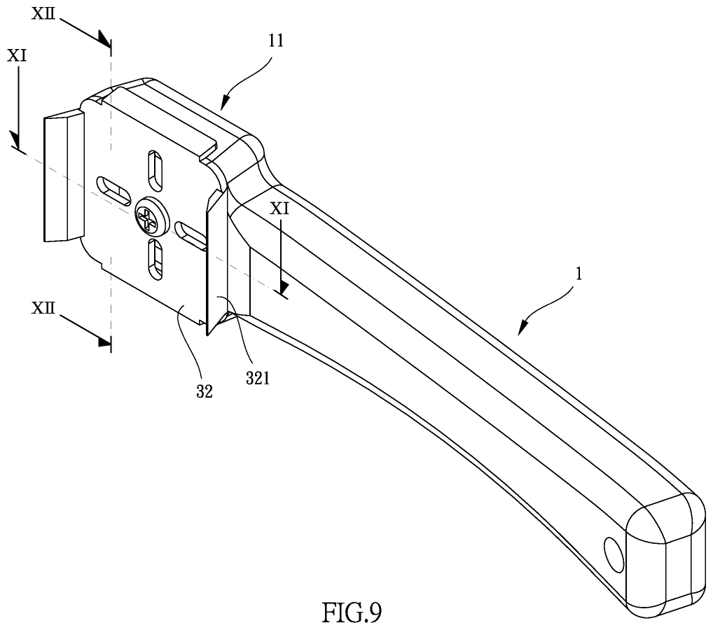

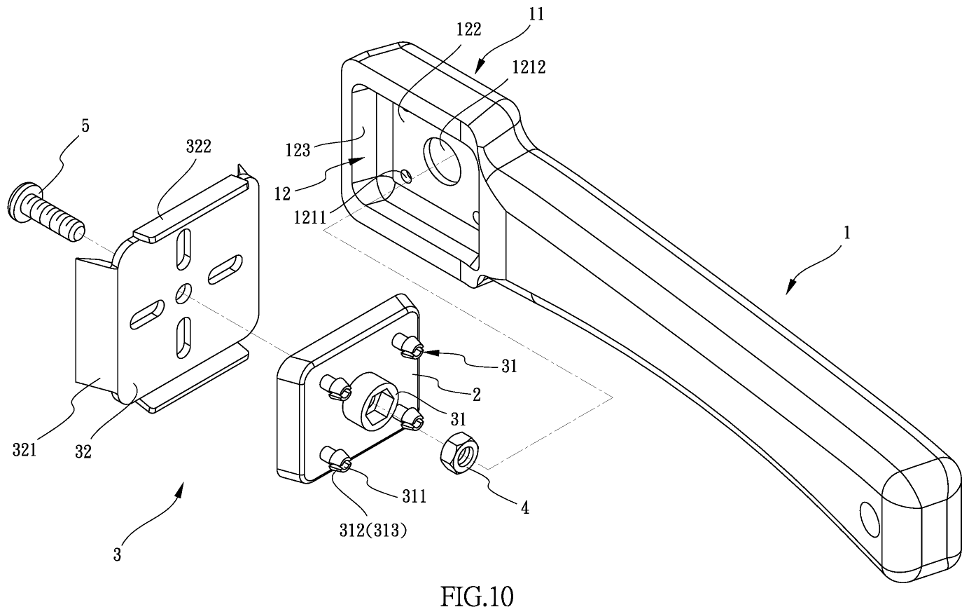

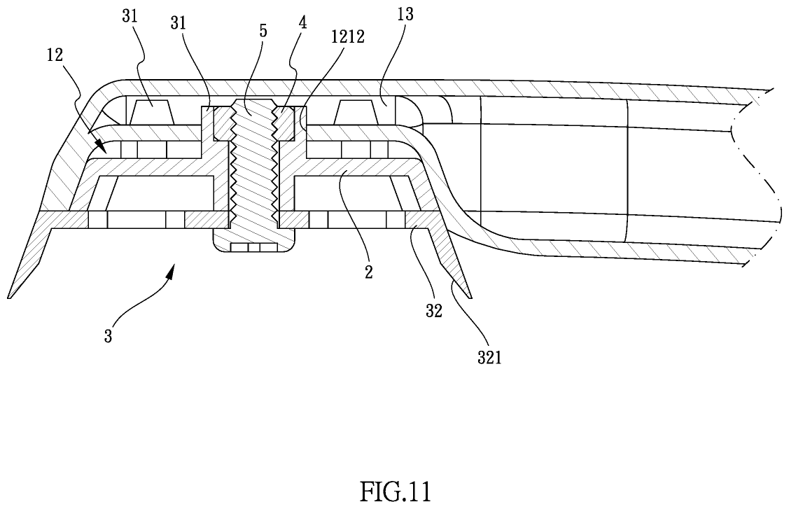

As shown in FIGS. 9 to 12, the second embodiment of the present invention is disclosed, the difference that the second embodiment has relative to the first embodiment is that the second embodiment includes a board 2 which has the top thereof accommodated in the recess 12 and includes multiple rods 31 which are engaged with the holes 121 of the recess 12. One of the rods 31 includes a nut 4 received therein. The rest of the rods 31 are engaged with the holes 121 by the same way described in the first embodiment. The function part 32 has the top thereof connected to the underside of the head 3, and an extension 321 extends from the underside of the function part 32. The bolt 5 extends through the function part 32 and is connected with the nut 4. The function part 32 is replaceable when the bolt 5 is disengaged from the nut 4.

The hole 121 of the connection potion 11 includes multiple first sub-holes 1211 and a second sub-hole 1212, wherein the first sub-holes 1211 are located around the second sub-hole 1212. The second sub-hole 1212 is located at the center of the first inner bottom of the recess 12. The diameter of the second sub-hole 1212 is larger than that of each of the first sub-holes 1211. The rods 31 in the second embedment have the same structure as the rods in the first embodiment. The rods 31 that are located corresponding to the first sub-holes 1211 each have a slit 311 which is defined axially through the rod 31 and opens to the distal end of the rod 31 corresponding thereto. A protrusion 312 is formed on the outer periphery of each of the rods 31 and includes an inclined face 313 which tapers outward from the distal end of the rod 31 toward the root of the rod 31. The inclined face 313 guides the rod 31 to be inserted into the first sub-hole 1211 corresponding thereto. The rod 31 is deformed because of the slit 311 is narrower to allow the protrusion 312 to pass through the first sub-hole 1211, and the protrusion 312 contacts the periphery of the first sub-hole 1211 after the protrusion 312 passes through the first sub-hole 121.

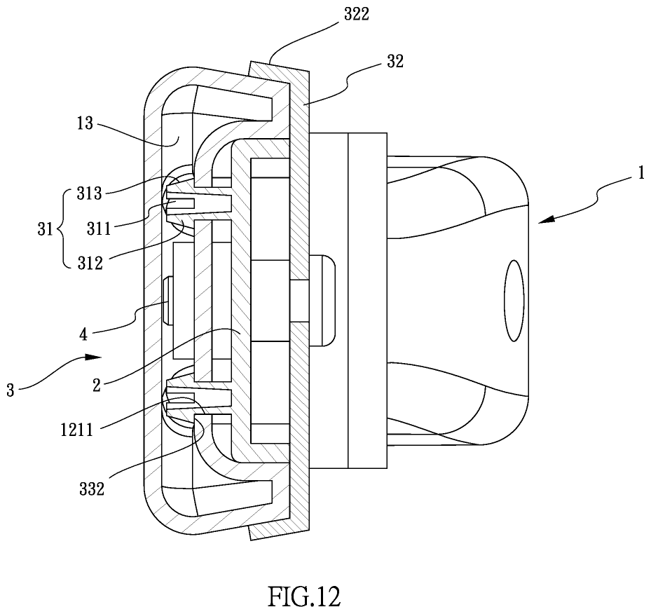

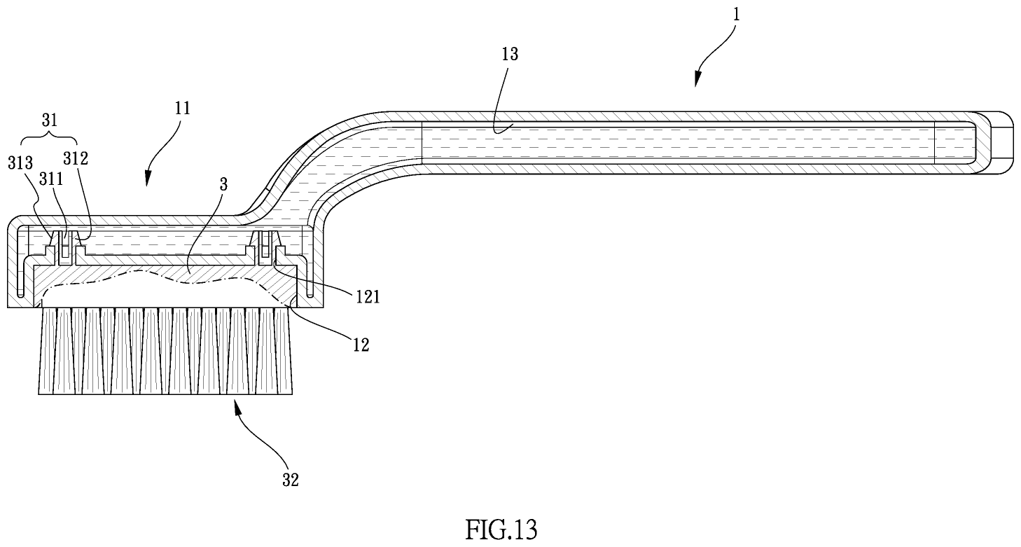

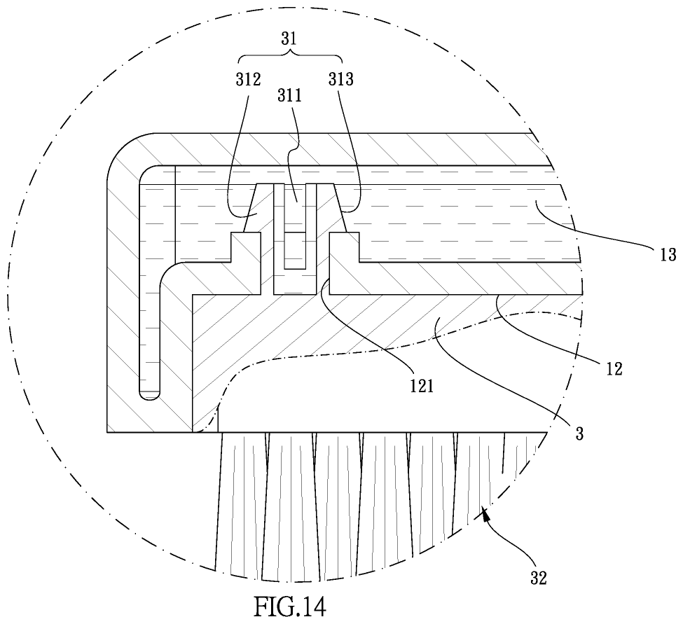

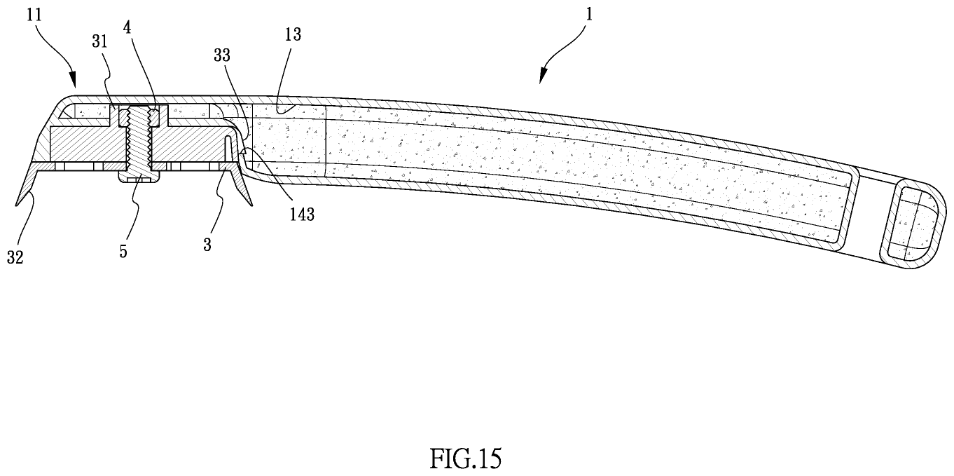

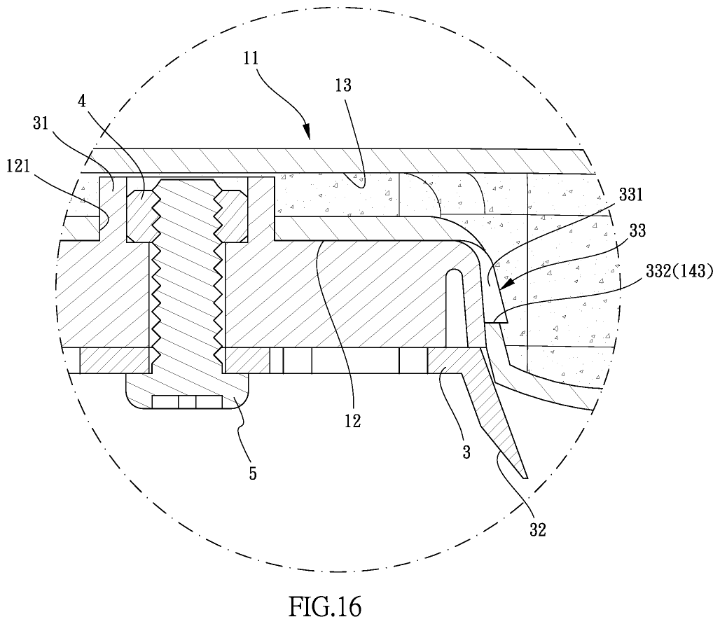

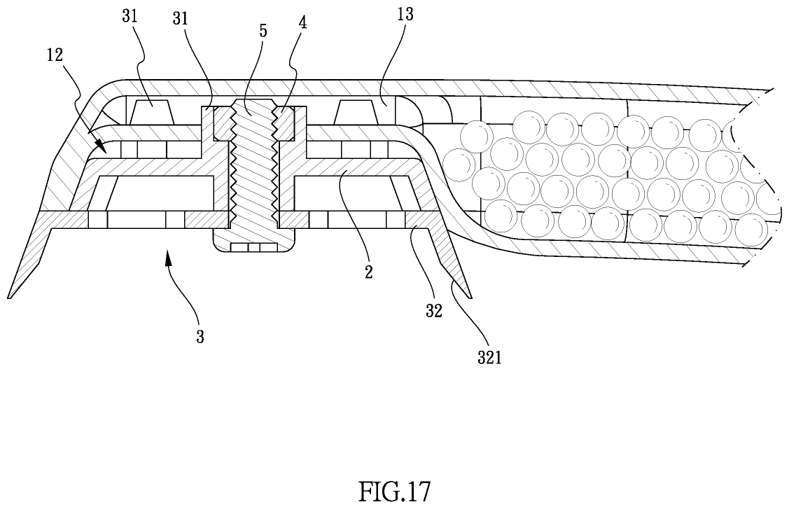

As shown in FIGS. 12 to 17, the hollow area 13 of the connection potion 11 if the first and second embodiment is filled with liquid, beads or sand so as to increase the weight such that some users feel similar as they use the other tools.

The extension 321 of the function part 32 in each of the first and second embodiments includes bristles or a scraper. The function part 32 can be replaced as needed, and the manufacturing is easy.

While we have shown and described the embodiment in accordance with the present invention, it should be clear to those skilled in the art that further embodiments may be made without departing from the scope of the present invention.

What is claimed is:

1. A hand tool assembly comprising:
a handle having a connection portion formed on one end thereof by way of blow molding, the connection portion having a recess defined therein which includes a first inner bottom, at least one hole defined through the first inner bottom of the recess, and
a head having a top accommodated in the recess and having at least one rod which is engaged with the at least one hole, at least one function part connected to an underside of the head and protruding beyond the recess.

2. The hand tool as claimed in claim 1, wherein a hollow area is defined in the connection portion, the at least one hole communicates with the hollow area.

3. The hand tool as claimed in claim 2, wherein a protrusion is formed on an outer periphery of the at least one rod and includes an inclined face which tapers outward from a distal end of the at least one rod toward a root of the at least one rod, the at least one rod of the head has a slit defined axially therethrough which opens to the distal end of the at least one rod, the inclined face guides the at least one rod to be inserted into the at least one hole of the first inner bottom of the recess, the at least one rod is deformed because of the slit to allow the protrusion to pass through the at least one hole, and the protrusion contacts a periphery of the at least one hole after the protrusion passes through the at least one hole.

4. The hand tool as claimed in claim 2, wherein a nut is located in the at least one rod of the head, a bolt extends through the underside of the head and is connected with the nut, the at least one rod is secured between the nut and the periphery of the at least one hole.

5. The hand tool as claimed in claim 4, wherein the recess includes the first inner bottom and multiple first sidewalls, one of the sidewalls includes a slot which includes a second inner bottom and two second sidewalls, the second inner bottom faces the recess, and the second sidewalls face an installation direction of the head, a bore is defined through the second inner bottom and communicates with the hollow area, the head includes a resilient member, the resilient member has one end thereof extending from one side of the head and a gap is formed between the resilient member and the head, a tongue protrudes from the resilient member, a stepped portion is formed between a distal end of the tongue and the resilient member, the resilient member is slid along the slot and the second inner bottom pushes the resilient member to narrow the gap until tongue is engaged with the bore to accommodate the head in the recess, a periphery of the bore is engaged with the stepped portion.

6. The hand tool as claimed in claim 1, wherein the at least one function part includes bristles or a scraper.

7. The hand tool as claimed in claim 6, wherein the hollow area of the connection potion is filled with liquid, beads or sand.

8. A hand tool assembly comprising;
a handle having a connection portion formed on one end thereof by way of blow molding, the connection portion having a recess defined therein which includes a first inner bottom, multiple holes defined through the first inner bottom of the recess;
a board having a top accommodated in the recess and having multiple rods which are engaged with the holes, one of the rods includes a nut received therein, and
a function part having a top thereof connected to an underside of the head, an extension extending from an underside of the function part, a bolt extending through the function part and connected with the nut, the function part being replaceable when the bolt is disengaged from the nut.

9. The hand tool as claimed in claim 8, wherein a hollow area is defined in the connection portion, each of the holes communicates with the hollow area.

10. The hand tool as claimed in claim 9, wherein the hole of the connection potion includes multiple first sub-holes and a second sub-hole, the first sub-holes are located around the second sub-hole, the second sub-hole is located at a center of the first inner bottom of the recess, a diameter of the second sub-hole is larger than that of each of the first sub-holes.

11. The hand tool as claimed in claim 10, wherein the rods that are located corresponding to the first sub-holes each have a slit which is defined axially through the rod and opens to a distal end of the rod corresponding thereto, a protrusion is formed on an outer periphery of each of the rods and includes an inclined face which tapers outward from the distal end of the rod toward a root of the rod, the inclined face guides the rod to be inserted into the first sub-hole corresponding thereto, the rod is deformed because of the slit is narrower to allow the protrusion to pass through the first sub-hole, and the protrusion contacts a periphery of the first sub-hole after the protrusion passes through the first sub-hole.

12. The hand tool as claimed in claim 11, wherein extension includes two scraping plates which are respectively located on two opposite ends of the function part, two side panels respectively extend from two opposite sides of the function part and match with two opposite outsides of the connection portion.

13. The hand tool as claimed in claim 9, wherein the extension includes bristles.

14. The hand tool as claimed in claim 12, wherein the hollow area of the connection potion is filled with liquid, beads or sand.
